(19) United States
(12) Patent Application Publication
(10) Pub. No.: US 2007/0044366 A1
(43) Pub. Date: Mar. 1, 2007

(54) Combination fishing garment and fishing rod holder and method of manufacture

(76) Inventor: David R. Walko, Punxsutawney, PA (US)

Correspondence Address: FLOYD B. CAROTHERS;CAROTHERS AND CAROTHERS, 445 FORT PITT BOULEVARD, SUITE 500, PITTSBURGH, PA, 15219, US

(21) Appl. No.: 11/216,943

(22) Filed: Aug. 31, 2005

(51) Int. Cl. A01K 97/10; A01K 97/06

(52) U.S. Cl. 43/21.2; 43/4; 43/54.1

(57) ABSTRACT

A combination fishing vest and fishing rod holder. The fishing rod holder includes two spaced pole rests, such as J-hooks, which are respectively secured to opposite sides of a front portion of a fishing vest for transversely supporting a fishing rod therebetween across the vest at a chest high position.

### BACKGROUND OF THE INVENTION

This invention relates to a fishing rod carrier or holder, and more particularly to a fishing rod holder which frees up the fisherman's hands for preparatory operations, such as tying on new flies, retrieving fish from the net or washing one's hands without permitting the fishing reel to engage or otherwise dip into the water.

Various types of rod carriers or holders have been devised for temporarily supporting a fishing rod and reel combination, particularly for use in fly fishing. However, some carriers are relatively inaccessible as they mount the rod to the back of the fisherman and other such carrier systems either place the rod in a position where it interferes with the use of the fisherman's hands when trying to accomplish other tasks, or the carrier holds the rod and reel in such a position that the fishing reel is easily and undesirably immersed into the water while the fisherman is accomplishing preparatory tasks.

It is a principal object of the present invention to provide a fishing rod holder which is devoid of these aforementioned shortcomings.

### SUMMARY OF THE INVENTION

The present invention provides a combination fishing garment and fishing rod holder wherein the combination includes an upper torso garment, such as a fishing vest, and a fishing rod holder, including two spaced pole rests respectfully secured to opposite sides of a front portion of the garment for transversely supporting a fishing rod therebetween across the garment at chest high. This rod holder provides temporary support for the rod and reel combination and because of the positioning at chest high it permits full unrestricted use of the fisherman's arms and hands for other preparatory tasks. Also, the rod is further so positioned whereby the reel cannot and will not engage the water in which the fisherman is standing, even if the fisherman leans over to wash his or her hands in the fishing waters.

The pole rests generally each include a J-hook to support the rod in. One of the J-hooks may include a spring biased keeper for closing the hook whereby a pole may be releaseably confined therein to assure that the pole does not accidently dislodge from the J-hook. The fishing line itself may also be fed through the same J-hook so that the clip also retains the line therein along with the pole.

The J-hooks may be sold separately, together with means for securing the J-hooks to ones fishing vest so that the fisherman may purchase the rod holder separately and secure to his or her own fishing vest.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a view in front elevation of the fishing garment and fishing rod holder of the present invention;

FIGS. 2A and 2B are enlarged views of the J-hooks used for the fishing rod holder shown in combination with means for securing the J-hooks to a fishing vest; and

FIGS. 3A and 3B are back side views of the J-hook with the spring biased keeper shown in FIG. 2B respectively in its closed and open positions.

### DETAILED DESCRIPTION OF A PREFERRED EMBODIMENT

Referring to the drawings, the combination fishing garment and fishing rod holder 10 is illustrated as a combination of upper torso garment 11 in the form of a fishing vest with a zipper front and fishing rod holder 12 provided by two spaced pole rests 13 and 14 secured to opposite sides of front portion 15 of garment 11 at chest high as illustrated, thereby leaving the wearer's arms free to perform various preparatory tasks.

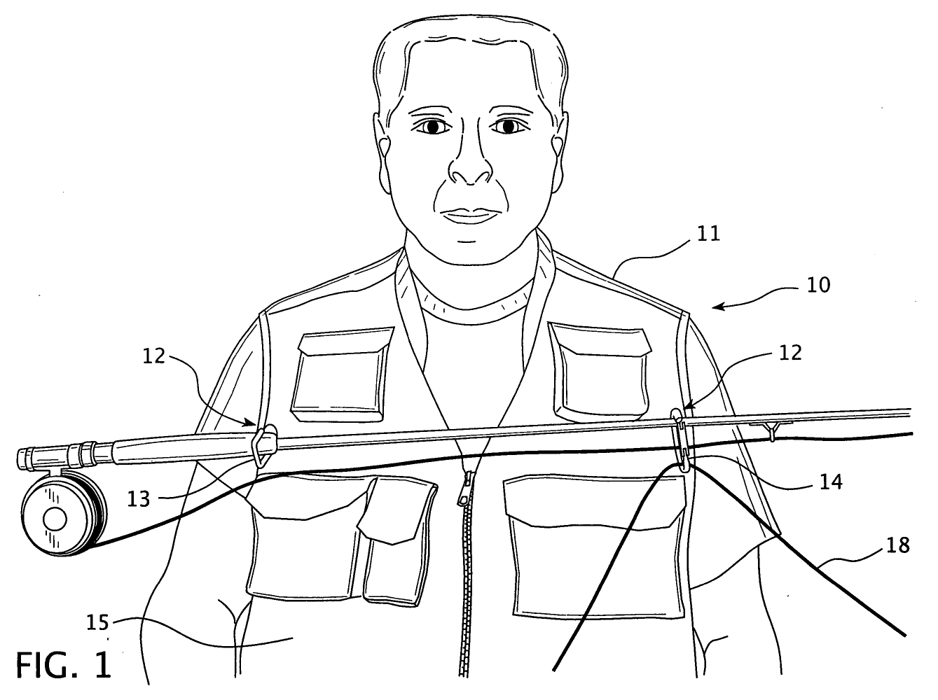

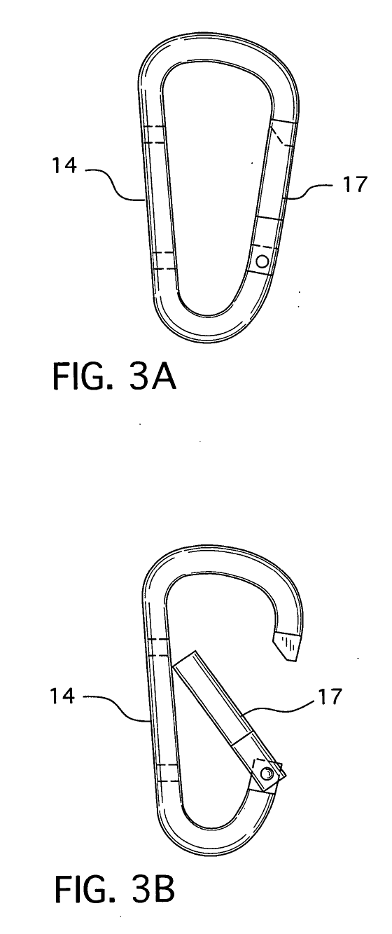

The two pole rest 12 are in the form of J-hooks. J-hook 13 is open and J-hook 14 is provided with a spring biased keeper 17 as is best illustrated in FIG. 3. This permits retention of the pole 16 and fishing line 18 therein as illustrated in FIG. 1 and prevents accidental dislodgement.

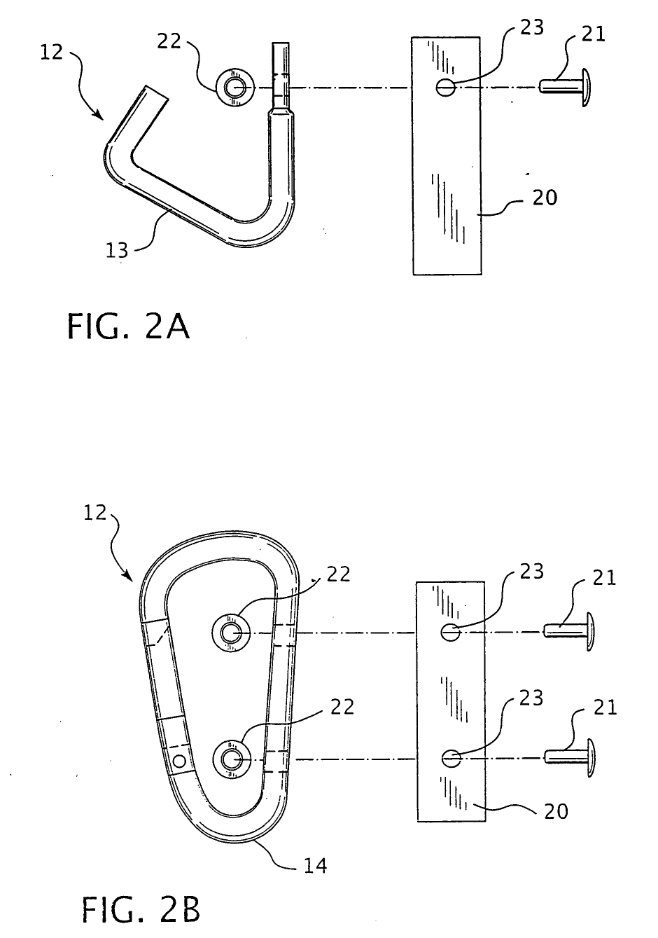

As is illustrated in FIGS. 2A and B, the J-hooks 13 and 14 may be provided separately with backup plates 20 provided with rivet openings 23, rivets 21 and rivet caps 22 to provide independent securement of the J-hooks 13 and 14 to the fishing vest of the purchaser.

1. A combination fishing garment and fishing rod holder comprising:
an upper torso garment;
a fishing rod holder including two spaced pole rests respectively secured to opposite sides of a front portion of said garment at chest high for transversely supporting a fishing rod therebetween across said garment at chest high;
said pole rests comprised respectively of vertically positioned J-hooks with one of said J-hooks being inverted.

2. The combination of claim 1, wherein said pole inverted J-hook includes a second J-hook opposing in alignment said inverted J-hook with a gap provided between distal ends of said opposing J-hooks for receiving a fishing rod therethrough.

3. The combination of claim 2, wherein said opposing J-hooks include a spring biased keeper for closing said gap whereby a pole may be releaseably confined therein between said opposing J-hooks.

4. The combination of claim 2, wherein said garment is a fishing vest.

5. A method for providing a combination fishing garment and fishing rod holder comprising:
providing an upper torso garment;
providing two pole rests in the form of J-hooks;
vertically securing the said J-hooks to said garment on opposite sides of a front portion thereof in spaced relationship at chest high with one of said J-hooks being upright and the other being inverted for thereby transversely supporting a fishing rod in cantilevered fashion therebetween across said garment at chest high with a reel end of the fishing rod positioned adjacent said upright J-hook but outside of the space intermediate said J-hooks.

6. (canceled)

7. (canceled)
